(19) United States
(12) Patent Application Publication
(10) Pub. No.: US 2002/0130818 A1
(43) Pub. Date: Sep. 19, 2002

(54) Methods and systems for exchanging information, such as nondestructive evaluation data, between distributed users

(76) Inventor: John R.M. Viertl, Niskayuna, NY (US)

Correspondence Address: PERKINS COIE LLP, PATENT-SEA, P.O. BOX 1247, SEATTLE, WA, 98111-1247, US

(21) Appl. No.: 10/087,462

(22) Filed: Mar. 1, 2002

Related U.S. Application Data
(63) Continuation-in-part of application No. 09/750,484, filed on Dec. 27, 2000.

(51) Int. Cl. G09G 5/00

(52) U.S. Cl. 345/1.1

(57) ABSTRACT

Methods and systems for providing distributed participants with test data, such as NDE data. In one embodiment, a test conductor controls test equipment to collect test data for a part. The test conductor controls the test equipment by operating a first user computer operatively connected to the test equipment. The test data is automatically sent from the test equipment to the first user computer, and from the first user computer to a server computer via a communications link, such as the Internet. The server computer forwards the test data to an application program that generates a display page containing at least a portion of the test data. The server computer then sends the display page to a second user computer located remotely from the first user computer. The second user computer can be operated by a distributed participant having an interest in the test.

### CROSS-REFERENCE TO RELATED APPLICATION(S)

This application is a continuation-in-part of U.S. patent application Ser. No. 09/750,484 entitled POINTER CONTROL SYSTEM, filed Dec. 27, 2000, and incorporated herein by reference.

### TECHNICAL FIELD

The following disclosure relates generally to transmitting information and, more particularly, to computer-implemented methods and systems for transmitting digital and image data related to nondestructive evaluation of mechanical parts.

### BACKGROUND

Nondestructive evaluation (NDE) generally refers to nondestructive methods for testing the structural integrity of mechanical parts. A number of sophisticated NDE techniques using ultrasonics, eddy currents, x-rays, infrared light, dye penetrants, magnetic particles and so on are in use today. A major advantage associated with NDE is that it allows the part being evaluated to be returned to service if the test shows the part to be acceptable for use.

NDE may be performed in a number of different scenarios during the manufacturing process. Some mechanical parts undergo NDE as a matter of course at different stages of manufacturing to ensure they conform to their engineering requirements. NDE may also be performed on a case-by-case basis when a part, often a relatively expensive part, fails to conform to one or more of its engineering requirements. In this situation, the NDE may be performed to demonstrate that, although the part does not meet the letter of its engineering requirements, it nevertheless will meet its functional requirements and therefore is acceptable for use.

NDE is also frequently used to test parts that have been installed and in use for a long period of time. For example, a routine inspection of a large land-based gas turbine may reveal a small surface crack in a turbine blade. Rather than simply discarding the turbine blade, it may be more cost-effective to x-ray the blade to determine the extent of the crack and whether the crack has rendered the blade unusable. To minimize cost, it will often be desirable to x-ray the turbine blade in situ, rather than removing the blade from the turbine and shipping the blade to a remote test lab for x-ray. This type of in situ x-ray testing is usually feasible with modern x-ray test equipment and other types of testing equipment.

Many manufacturers of complex machinery contract with outside suppliers to provide parts and subassemblies that the manufacturers assemble into finished products at their plants. For example, a manufacturer of steam turbines for use in power plants may contract with an outside supplier to provide turbine blades. For ease of reference, such manufacturers may be referred to here as “contractors.” After the turbine blades have been assembled into a steam turbine, the contractor usually transports the steam turbine to a remote customer site, such as a power plant, for installation and operational service. The customer may have a number of such remote power plants that it operates and oversees from a home office. When there is a problem at one of the remote power plants, the customer will often monitor resolution of the problem from the home office.

In the foregoing example, there are at least four separate entities located remotely from each other that may have an interest in the performance of the turbine blades. The first entity is the part supplier that manufactured the turbine blades, the second entity is the contractor that assembled the blades into the steam turbine, the third entity is the customer power plant, and the fourth entity is the customer home office. Because the turbine blades are manufactured at the part supplier location and are put into operational service at the customer power plant, NDE of such parts is typically conducted at either the part supplier or the customer power plant.

Even though NDE of many parts, such as the turbine blades discussed above, is conducted remotely from the contractor, the results of the NDE are typically sent to the contractor for evaluation. This is because the contractor usually has the technical expertise required to evaluate the results of the NDE and to determine the adequacy of the part, and because the contractor often has the ultimate responsibility for the performance of the part. Alternatively, a team of contractor engineers could travel to the test site to conduct the NDE, however, this approach is generally not cost-effective. Typically, NDE results are mailed, shipped as paper records, or hand-carried on various storage media (e.g., floppy disk, removable hard drive or CD-ROM) to the contractor from either the part supplier or the customer site for evaluation. When a part in the field, such as a turbine blade, undergoes NDE, the piece of equipment it is installed on, such as a steam turbine, is often shut down and taken out of service while the part is being evaluated. As a result, it is often desirable to expedite the NDE process so that the equipment can be returned to service as soon as possible to minimize any loss of revenue.

Conventional methods for conducting NDE of mechanical parts at remote sites have a number of drawbacks. For example, these methods do not allow a contractor or a customer home office to monitor the NDE or to make real-time assessments of the data collected. In addition, providing the results of the NDE to a contractor or customer home office can be very time-consuming using these methods. As a result, after the NDE has been conducted the contractor may determine that the test setup was inadequate or that the data is insufficient, in which case the NDE may have to be repeated. These drawbacks can lead to a time-consuming, back-and-forth exchange of NDE results between the remotely located test conductor and the contractor or the customer home office. Thus, methods and systems that can expedite NDE-related processes are desirable.

### BRIEF DESCRIPTION OF THE DRAWINGS

FIG. 1 is a diagram illustrating a display page containing various forms of NDE data in accordance with an embodiment.

FIG. 2 is a block diagram illustrating components of a remote test monitoring system in one embodiment.

FIG. 3 is a flow diagram illustrating processing of a test data exchange component of a user computer in one embodiment.

FIG. 4 is a flow diagram illustrating a routine of a launch application component of a server computer in one embodiment.

FIG. 5 is a flow diagram illustrating a routine of a process application input component of a server computer in one embodiment.

FIG. 6 is a flow diagram illustrating a routine for a process application output component of a server computer in one embodiment.

### DETAILED DESCRIPTION

The following disclosure describes methods and systems that allow distributed participants to remotely monitor the acquisition of test data and the setup of test equipment. For example, in one embodiment, a test conductor located at a remote site conducts a nondestructive evaluation (NDE) of a part installed on a piece of operational equipment located at the site. The test conductor performs the NDE of the part by operatively connecting a piece of test equipment, such as an x-ray machine, to a user computer that can control the test equipment. The test conductor then operates the user computer to acquire and display NDE test data from the test equipment. In one aspect of this embodiment, this test data is then sent from the test conductor's user computer to distributed participant user computers, such as a contractor user computer and a customer user computer, via a communications link. The test data is then displayed on the contractor and customer user computers so that the contractor and the customer can monitor the NDE of the part in real time.

In another embodiment, the system allows the distributed participants to remotely communicate with the test conductor by transmitting voice or text messages over the communications link to the test conductor. In this way, if the contractor or customer wants to alter how the NDE is being performed, he or she can instruct the test conductor accordingly in real time. In contrast to conventional NDE systems, the present system disclosed herein provides distributed participants with almost immediate access to NDE data. As a result, the cycle time for performing NDE of parts can be reduced, allowing equipment to be returned to service quickly and thereby reducing the loss of revenue associated with equipment downtime.

Certain embodiments of the methods and systems described herein for remotely monitoring test activities are described in the context of computer-executable instructions performed by a general-purpose computer, such as a personal computer. In one embodiment, for example, these computer-executable instructions are stored on a computer-readable medium, such as a floppy disk or CD-ROM. In other embodiments, instructions are stored on a server computer system and accessed via a communications link or computer network, such as an intranet or the Internet. Because the basic structures and functions related to computer-readable routines and corresponding implementation systems are well known, they have not been shown or described in detail here to avoid unnecessarily obscuring the described embodiments. Although the following disclosure provides specific details for a thorough understanding of several embodiments of the remote test monitoring system, those of ordinary skill in the relevant art will understand that these embodiments may be practiced without some of the details provided. In other instances, it will be appreciated that the methods and systems described can include additional details without departing from the spirit or scope of the disclosed embodiments.

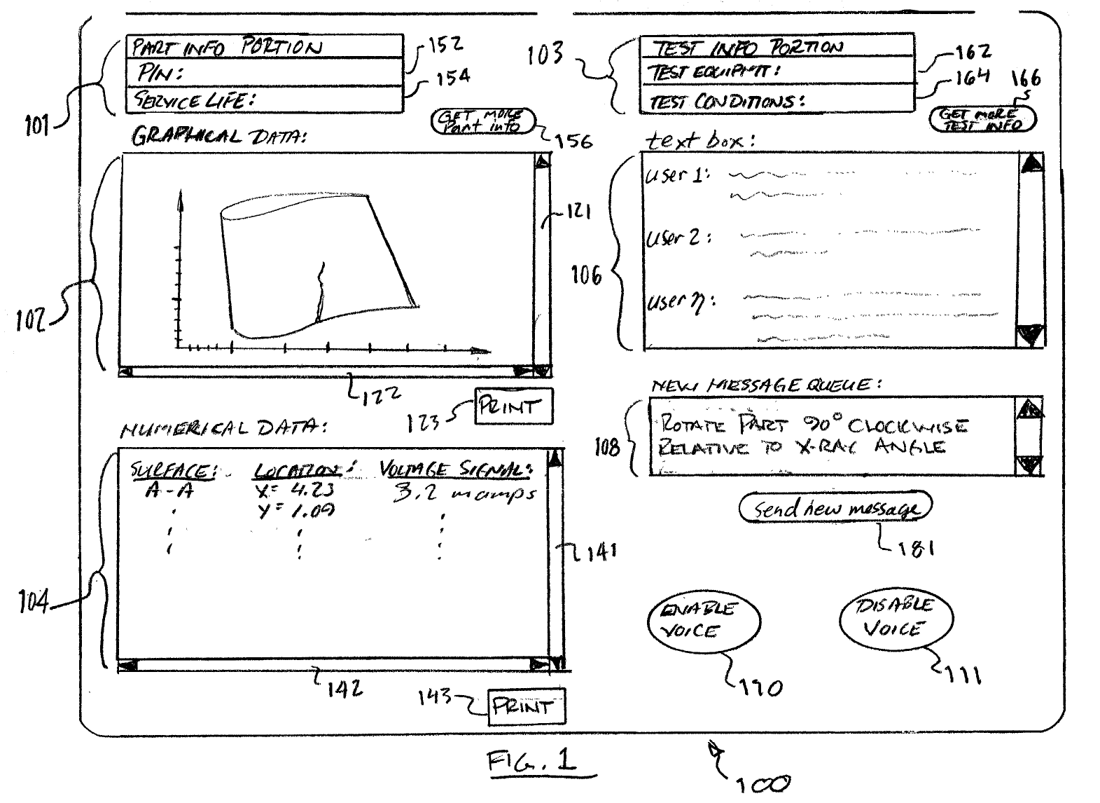

FIG. 1 is a diagram illustrating a display page 100 containing various forms of test data, such as NDE data, in accordance with an embodiment. In the illustrated embodiment, the display page 100 includes a part information portion 101, a test information portion 103, a graphical data portion 102, and a numerical data portion 104. The part information portion 101 includes various information related to the part being tested. For example, the part number and serial number of the part are shown in a part identification field 152. The service life of the part is included in a part history field 154. For example, the part history field 154 can include information such as when the part was installed and when it was last inspected. If the user desires more information about the part being tested, the user can click on a “more part information” button 156. Clicking this button will bring up one or more display pages containing additional part information, such as the material the part is made from, the operating conditions the part was designed for (e.g., temperatures and pressures), and any repair history or other information that may be relevant to the part.

The test information portion 103 includes various information related to the test equipment that is testing the part. For example, the model and serial number of the test equipment are included in a test equipment identification field 162. Test conditions information is included in a test conditions field 164. For example, in the case of an x-ray test, this field can include information such as the part orientation and the distance between the x-ray source and the part. In other embodiments, other test conditions information can be included in the test conditions field 164. For example, in an eddy current test, the applied voltage and the maximum change in inductance can be included in this field. If the user desires more information about the test, the user can click on a “more test information” button 166. Clicking this button will bring up one or more display pages containing additional test information, such as when the particular piece of test equipment was last calibrated, margin of error in the test data, and any other information that may be relevant to the test.

The display page 100 further includes test data, such as NDE data, in the graphical data portion 102 and the numerical data portion 104. The graphical data portion 102 can include graphical data related to NDE, such as an x-ray image, an ultrasonic image, a plot of eddy current data, or an infrared thermal image. In other embodiments, the graphical data portion 102 can display other types of data. The graphical data portion 102 includes a vertical scroll bar 121 and a horizontal scroll bar 122 that allow a user to scroll the data vertically and horizontally, respectively, as desired. In addition, the graphical data portion 102 includes a print button 123 that allows the user to print a hard copy of the displayed data using an associated printer.

The numerical data portion 104 can include various types of numerical data related to NDE, such as numerical ultrasonic and eddy current data. In other embodiments, other types of numerical data can be included in the numerical data portion 104, such as dimensional data defining the size and location of a material defect in a part. Like the graphical data portion 102, the numerical data portion 104 includes a vertical scroll bar 141 and a horizontal scroll bar 142. Similarly, the numerical data portion 104 also includes a print button 143 that allows the user to print a hard copy of portions of the numerical data using the associated printer.

In addition to displaying various types of NDE test data, the display page 100 also provides functionalities for voice and textual interaction between distributed participants. For example, in one embodiment, the display page 100 includes a text box 106 and a new message queue 108. The text box 106 displays a running list of text messages entered by one or more distributed participants during a given NDE test. A user can enter a new text message in the text box 106 by typing the message in the new message queue 108. Once satisfied that the new message is ready to be sent, the user sends the message to the other participants by clicking on a send message button 181. In one aspect of this embodiment, the text messages are presented in order of receipt, and each message identifies the corresponding sender. The text box 106 allows one or more distributed participants, such as a contractor or a customer, to communicate directly with the test conductor in real time during the performance of the NDE.

In addition to communicating by using text messages, in another embodiment, the participants can communicate by using voice messages. Any participant desiring to use this functionality will accordingly need to have the associated microphone and speaker systems available on their user computer. If these systems are available, then the participant can transmit voice messages to other participants by clicking on an enable voice button 110. In the event the participant wishes to no longer transmit voice messages, the participant can accordingly click a corresponding disable voice button 111. Although selected aspects of the display page 100 have been described above for purposes of illustration, those of ordinary skill in the relevant art will appreciate that other functionality can be included to supplement or facilitate the exchange of data, such as NDE data, without departing from the spirit or scope of the present disclosure.

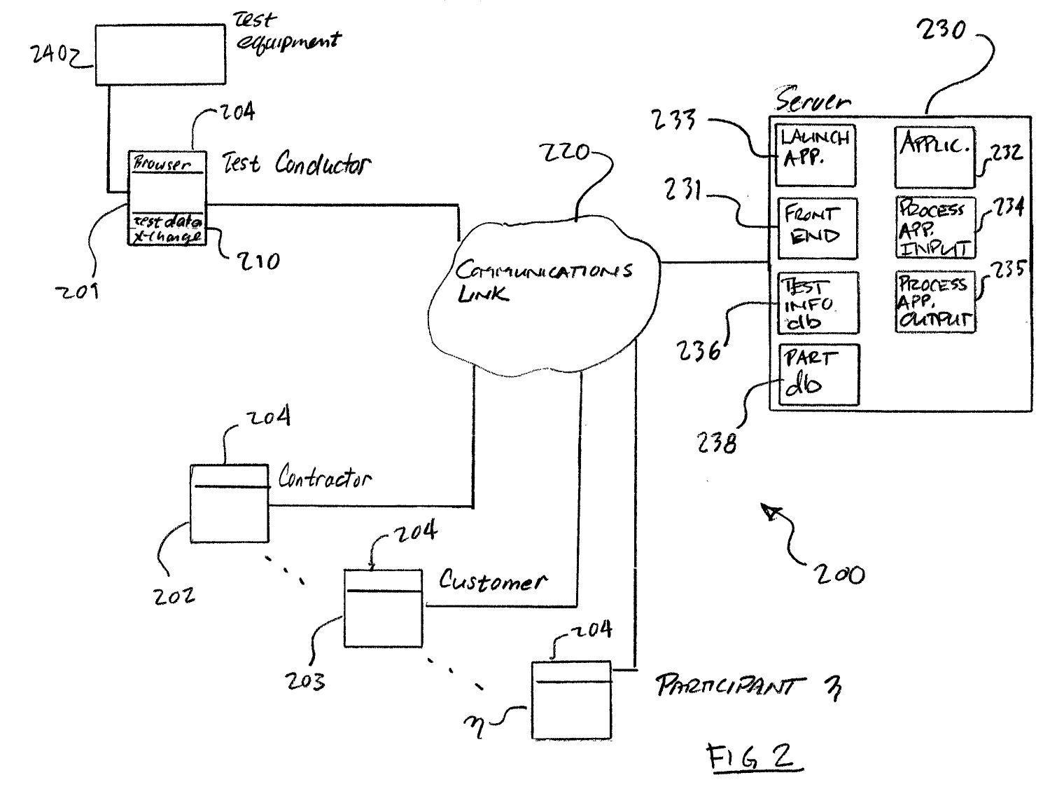

FIG. 2 is a block diagram illustrating components of a remote test monitoring system 200 in one embodiment. One or more user computers, such as user computers 201-203, are connected to a server computer 230 via a communications link 220. The user computers 201-203 may be general-purpose computers, such as personal computers, and may include a central processing unit, memory devices, input devices (e.g., keyboard and pointing devices), output devices (e.g., display devices), and storage devices (e.g., disk drives). Memory and storage devices are computer-readable media that may contain computer instructions for implementing methods and systems, such as routines and display pages, in accordance with this disclosure. The user computers 201-203 may include a browser module 204 that allows participants of the remote test monitoring system 200 to access and exchange data with the communications link 220, including web sites within the World Wide Web portion of the Internet. In a further aspect of this embodiment, the communications link 220 is a computer network, such as a local area network (LAN), an intranet, or the Internet.

In one embodiment, the user computer 201 can be operated by a test conductor, such as a test conductor performing an NDE of a part, such as a turbine blade, at a remote test site, such as a remote customer power plant. The user computer 202 can be operated by a contractor located remotely from the test site, such as the contractor who provided the steam turbine to the customer power plant. In a further aspect of this embodiment, the user computer 203 can be operated by a customer located remotely from the test site, such as the customer who owns and operates the power plant. In addition to the foregoing, the remote test monitoring system 200 can also include other user computers operated by other system participants.

The remote test monitoring system 200 illustrated in FIG. 2 further includes test equipment 240 operatively connected to the user computer 201. The test equipment 240 is usable to perform NDE of hardware and mechanical parts, such as turbine blades. For example, the test equipment 240 can be an x-ray test machine, an ultrasonic test machine, an eddy current test machine, or an infrared thermal imaging test machine. In other embodiments, the test equipment 240 may be other types of test equipment, such as a load cell for performing stress, strain, or deflection tests. The test equipment 240 is operatively connected to the user computer 201 so that the test conductor can control the test equipment with the user computer to acquire test data and display the test data on the user computer. In a further aspect of this embodiment, the user computer 201 includes a test data exchange component 210. As will be described in greater detail below, the test data exchange component 210 receives test data from the test equipment 240 and sends this data via the communications link 220 to the server computer 230.

The server computer 230 includes a front-end component 231, an application program 232, a launch application component 233, a process application input component 234, a process application output component 235, a test information database 236, and a part database 238. The front-end component 231 controls the launching of the application program 232, the transferring of application input and output data, and the transfer of data to and from the test information database 236 and the part database 238.

The test information database 236 contains various information related to tests and test equipment. For example, this database can include information about the various pieces of test equipment that may be used for a particular test, such as the equipment model and serial number, applicable testing ranges, when the equipment was last calibrated, and any margin of error associated with the equipment. Information stored in the test information database 236 can be retrieved in response to a request from one of the user computers 201-203 and sent to the requesting user computer. The information can be sent in any number of forms, including display pages generated by the application program 232.

The part database 238 contains various information related to parts. In one aspect of this embodiment, the part database 238 contains vital statistics about the parts that could potentially be tested. For example, the part database 238 can include information such as how long a particular part has been in service; whether the part has ever been repaired; if the part has ever undergone a prior test or inspection, and if so, what the prior test or inspection revealed; and the name of the supplier that manufactured the part. Information stored in the part database 238 can be retrieved in response to a request from one of the user computers 201-203 and sent to the requesting user computer. The information can be sent in any number of forms, including display pages generated by the application program 232.

Aspects of one embodiment of the remote test monitoring system 200 can be described in accordance with the following example. The test conductor operating the user computer 201 accesses a web site on the server computer 230 and requests a display page. The test conductor enters identifiers on this display page, such as electronic addresses, of the distributed participants the conductor wishes to provide with real-time test data. The test conductor then utilizes the user computer 201 to transmit these electronic addresses over the communications link 220 to the server computer 230. The front-end component 231 receives the electronic addresses of the distributed participants and directs the launch application component 233 to establish connections with the distributed participants and start the application program 232.

During the NDE of a part in question with the test equipment 240, test data is sent from the test equipment to the user computer 201. The test data exchange component 210 receives this test data and sends at least a portion of it to the server computer 230 via the communications link 220. The front-end component 231 receives this data and provides it to the process application input component 234, which in turn forwards the input to the application program 232. The process application output component 235 receives the output of the application program and forwards it to the various distributor participant user computers for display. In addition, the process application output component 235 can store at least a portion of the application output in the test information database 236 for later retrieval. Accordingly, using the system and routines described above, distributed participants, such as the contractor and the customer, can receive test data in real time from the NDE being conducted by the remotely located test conductor.

In another embodiment, the remote test monitoring system 200 can be configured to allow the contractor to remotely control the test equipment 240 with the remotely located user computer 202, thereby eliminating the need for an onsite test conductor. In this embodiment, a person at the test site operatively connects the user computer 201 to the test equipment 240 and sends an electronic address for the remotely located user computer 202 to the server computer 230. The front-end component 231 receives the electronic address and directs the launch application component 233 to establish a connection with the user computer 202 and start the application program 232. Subsequently, during the NDE of the part in question by the test equipment 240, test data is automatically sent from the test equipment to the user computer 201. The test data exchange component 210 receives this test data and automatically sends at least a portion of it to the server computer 230 for processing as explained above. The server computer 230 then forwards at least a portion of this data (e.g., in display page form) to the user computer 202 for display. After reviewing this data, the contractor can input control instructions into the user computer 202 that are sent to the test equipment 240 via the communications link 220, the server computer 230, and the user computer 201. These control instructions can be used to control the test equipment 240 and change one or more of the test conditions or test equipment settings in accordance with the contractor's wishes. Accordingly, this alternate embodiment gives the remotely located contractor direct control of the NDE and eliminates the need to have an on-site test conductor.

In another embodiment, the user computer 201 located at the test site may be eliminated. In this embodiment, the test equipment is configured to establish a direct connection with the server computer 230 via the communications link 220, for example, by using a connectionless protocol such as HTTP. Accordingly, as the test equipment 240 collects test data, the data is automatically sent directly to the server computer 230. The server computer 230 processes the data as explained above and then sends it to the electronic address of a remote participant, such as the contractor. The contractor may then remotely control the test equipment 240 by operating the user computer 202, as explained above.

In yet another embodiment, the server computer 230 may be eliminated and the user computer 201 located at the test site may communicate directly with a participant user computer, such as the user computer 202, in a “peer-to-peer” relationship. In this embodiment, the user computer 201 is linked to the user computer 202 via a direct connection (not shown in FIG. 2). NDE test data is sent from the test equipment 240 to the user computer 201. The test data exchange component 210 receives this test data and sends at least a portion of it directly to the user computer 202. The test data may be processed by the user computer 201 and sent to the user computer 202 as a display page, or, alternatively, the test data may be processed by the user computer 202. In a further aspect of this embodiment, the contractor may remotely control the test equipment 240 by operating the user computer 202 as explained above.

While selected aspects of the remote test monitoring system have been described above for purposes of illustration, those of ordinary skill in the relevant art will appreciate that various other functionalities can be combined with this system to further enhance its utility. For example, in addition to providing distributed participants with test data, the system can also provide participants with part data for analyzing the part in light of the test data. As an example, consider a part wherein an NDE has disclosed a crack or similar defect. In this scenario, the contractor may want to determine whether the crack is significant enough to warrant discarding the part. Accordingly, the contractor can request part data, such as operating conditions (e.g., operating loads, temperatures, etc.) and design details (e.g., material strength, part dimensions, etc.) from the part database 238. In this illustrative example, using this part data, the contractor can perform a failure analysis of the part.

In a further embodiment, the application program 232 can include analytical functionality enabling a part defect to be automatically analyzed. In this embodiment, NDE data from the test equipment 240 and part data from the part database 238 are input to the application program 232. The application program 232 then structurally analyzes the part based on the defect data and the part operating conditions and design details and sends the results of this analysis to one or more of the distributed participants.

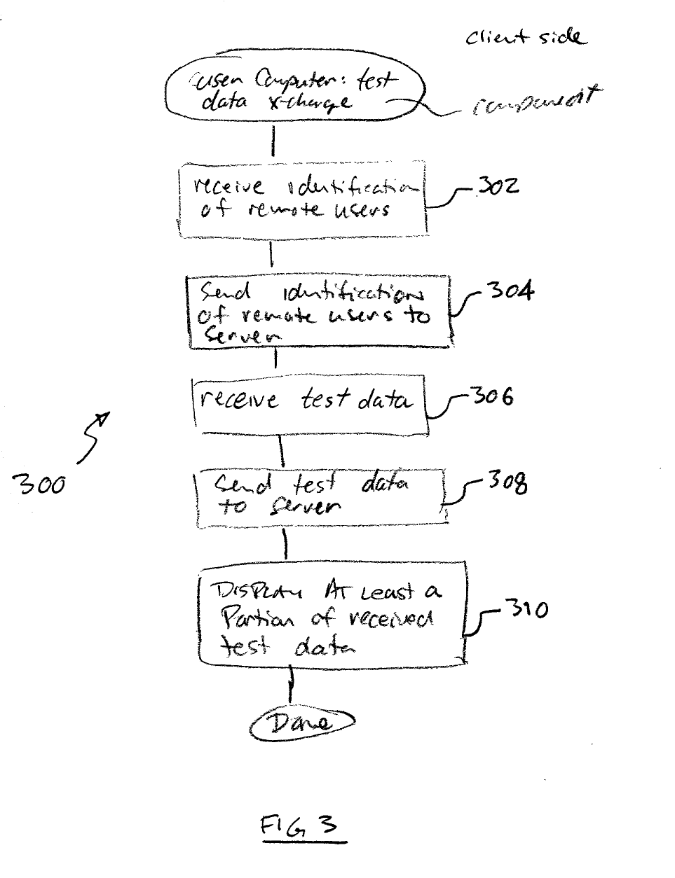

FIG. 3 is a flow diagram illustrating the processing of the test data exchange component 210 of the user computer 201 of FIG. 2 in one embodiment. In block 302, the component receives an identification of a distributed participant. This identification may be the result of a participant, such as the test conductor, inputting an electronic, address for one or more distributed participants, such as the remotely located contractor or customer. In block 304, the component sends the received identification to the server computer 230. In block 306, the component receives test data. In one embodiment, this test data corresponds to NDE data received from the test equipment 240 operatively connected to the user computer 201. In block 308, the component sends the received test data to the server computer 230. As will be described in greater detail below, in a further aspect of this embodiment, the server computer 230 then processes this test data and forwards it to the distributed participants identified in block 302. In block 310, the component can cause at least a portion of the received test data to be displayed on the hosting user computer 201 for viewing by the test conductor to complete the routine.

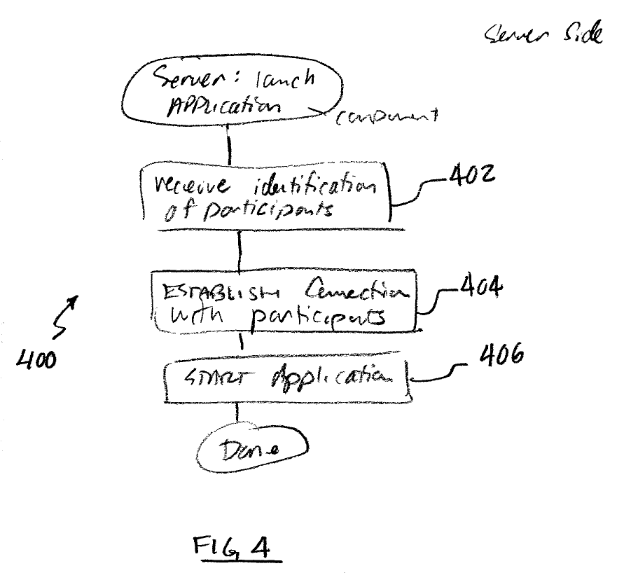

FIG. 4 is a flow diagram illustrating the routine of the launch application component 233 of the server computer 230 shown in FIG. 2 in one embodiment. In block 402, the component receives identification of one or more distributed participants who are supposed to receive test data in real time. For example, the component may receive electronic addresses for the contractor user computer 202 and the customer user computer 203. In block 404, the component establishes a connection with each of the identified participant user computers. These connections can be established using various communication protocols, such as TCP/IP. The remote test monitoring system may alternatively use connectionless protocols, such as HTTP. In block 406, the component starts the application program and then completes.

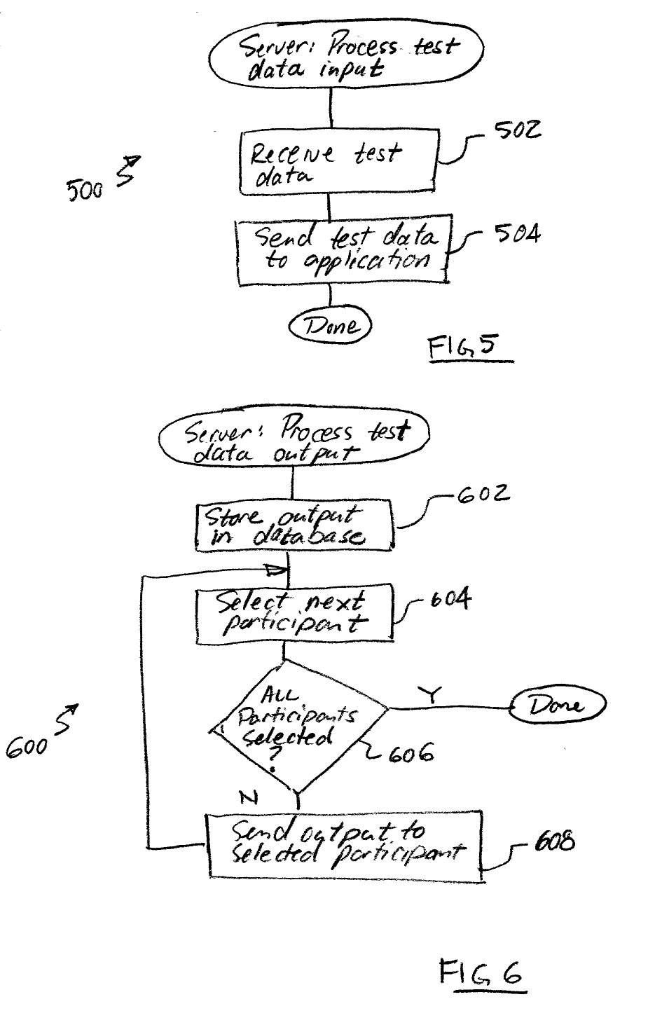

FIG. 5 is a flow diagram illustrating a routine 500 of the process application input component 234 of the server computer 230 shown in FIG. 2 in one embodiment. This component receives the test data generated by the test equipment 240 and forwards this data as input to the application program 232. In block 502, the component receives test data from the test equipment 240 via the user computer 201 and the communications link 220. In block 504, the component sends the test data as input to the application program 232 and then completes.

FIG. 6 is a flow diagram illustrating a routine 600 for the process application output component 235 of the server computer 230 shown in FIG. 2 in one embodiment. This component receives output from the application program 232 and forwards it to the various participant user computers for display. In block 602, the component may store at least a portion of the output of the application program in the test information database 236. In block 604, the component selects the next participant, starting with the first participant identified. In decision block 606, if all the participants have already been selected, then the component completes; otherwise, the component continues to block 608. In block 608, the component sends the output from the application program 232 to the user computer of the selected participant. The routine then loops back to block 604 to select the next participant.

It will be appreciated from the foregoing that although specific embodiments of the remote test monitoring system are described here for purposes of illustration, various modifications may be made without departing from the spirit or scope of the invention. For example, in one embodiment, in addition to providing remote participants with access to real-time test data, the system can also provide the remote participants with their own individual pointers to further enhance communication and interaction with the other distributed participants. In one embodiment, the pointer system is used when the application program is to be shared by multiple participants. At each participant's user computer, the pointer system displays a pointer for each participant. When one participant moves his or her pointer, the pointer system updates that participant's pointer on the display of the other participant user computers. In addition, the pointer system may display each pointer in a visually distinct manner so that the participants can identify which pointer belongs to which participant. For example, each of the pointers may have a unique color associated with the individual participants. In this way, the participants can simultaneously point to different portions of the various displays generated by the application program. This pointer system is disclosed in related U.S. patent application Ser. No. 09/750,484, entitled POINTER CONTROL SYSTEM filed on Dec. 27, 2000 and incorporated herein by reference.

Although the methods and systems have been described in the context of NDE of parts and subassemblies, it will be understood by those of ordinary skill in the relevant art that the methods and systems disclosed herein are equally well suited to allow remote participants to monitor other types of information, such as performance output of power plants or other types of quantitative information unrelated to NDE per se. These and other changes may be made to the invention in light of the above-detailed description.

While certain aspects of the invention are presented below in certain claim forms, the inventor nevertheless contemplates additional embodiments of the invention consistent with other claim forms. Accordingly, the inventor reserves the right to add additional claims after filing the application to pursue such additional claim forms for all aspects of the invention as contemplated. Further, the terms used in the following claims should not be construed to limit the invention to the specific embodiments disclosed above in the specification or the claims, but, instead, should be construed to include all remote monitoring systems that operate in accordance with the claims. The scope of the invention is therefore not limited by this disclosure, but, instead, the scope of the invention is to be determined entirely by the following claims.

I claim:

1. A method in a computer system for providing distributed participants with test data, the method comprising:
receiving identification of at least one participant computer that will receive the test data;
receiving the test data;
in response to receiving the test data, sending the received test data to an application program; and
sending a display page generated by the application program to each identified participant computer, the display page containing at least a portion of the received test data.

2. The method of claim 1 wherein the test data is received and sent to the application program in real time.

3. The method of claim 1 wherein:
receiving identification of at least one participant computer includes receiving identification of at least one participant computer from a test computer located in a first location; and
sending a display page generated by the application program to each identified participant computer includes sending the display page to a first participant computer and a second participant computer, the first participant computer being located in a second location remote from the first location and the second participant computer being located in a third location remote from the first and second locations.

4. The method of claim 1 wherein receiving identification of at least one participant computer includes receiving identification of at least one participant computer from a test computer, and wherein the method further comprises sending the display page generated by the application program to the test computer.

5. The method of claim 1 wherein:
receiving identification of at least one participant computer includes receiving identification of at least one participant computer from a test computer; and
receiving the test data includes automatically receiving the test data from the test computer, the test data being generated by test equipment operatively connected to the test computer.

6. The method of claim 5 wherein the test equipment is an x-ray test machine.

7. The method of claim 5 wherein the test equipment is an ultrasonic test machine.

8. The method of claim 5 wherein the test equipment is one of an eddy current test machine and an infrared thermal imaging test machine.

9. The method of claim 1 wherein receiving identification of at least one participant computer includes receiving identification of at least one participant computer from a test computer, wherein the display page is a first display page, and wherein the method further comprises:
in response to sending the first display page generated by the application program to each identified participant computer, receiving, from at least one participant computer, a comment related to the test data; and
sending at least a portion of the comment to the test computer.

10. The method of claim 9 wherein receiving the comment includes receiving audio content, and wherein sending at least a portion of the comment includes sending audio content.

11. The method of claim 9 wherein receiving the comment includes receiving textual content, and wherein sending at least a portion of the comment includes sending textual content.

12. The method of claim 1 wherein receiving identification of at least one participant computer includes receiving identification of at least one participant computer from a test computer, wherein the display page is a first display page, and wherein the method further comprises:
in response to sending the first display page generated by the application program to each identified participant computer, receiving, from at least one participant computer, a comment related to the test data;
in response to receiving the comment, sending the received comment to the application program; and
sending a second display page generated by the application program to at least the test computer, the second display page containing at least a portion of the received comment.

13. The method of claim 1 further comprising:
receiving a part identifier, wherein the part identifier identifies the part associated with the test data;
in response to receiving the part identifier, retrieving part data associated with the identified part from a database; and
sending the retrieved part data to the application program, wherein the display page generated by the application program includes at least a portion of the retrieved part data.

14. The method of claim 1 further comprising:
receiving a part identifier, wherein the part identifier identifies the part associated with the test data;
in response to receiving the part identifier, retrieving part data associated with the identified part from a database; and
sending the retrieved part data to the application program, wherein the display page generated by the application program includes analytical results based at least in part on the received test data and the retrieved part data.

15. The method of claim 14 wherein the retrieved part data includes operating conditions.

16. The method of claim 14 wherein the retrieved part data includes design details.

17. A method in a computer system for providing distributed participants with test data, the method comprising:
receiving identification of at least one participant computer that will receive the test data;
receiving the test data; and
in response to receiving the test data, sending at least a portion of the received test data to each identified participant computer.

18. The method of claim 17 wherein the test data is received and sent to the each identified participant computer in real time.

19. The method of claim 17 wherein:
receiving identification of at least one participant computer includes receiving identification of at least one participant computer from a test conductor located in a first location; and
sending the received test data to each identified participant computer includes sending the test data to a first participant computer located in a second location remote from the first location and a second participant computer located in a third location remote from the first and second locations.

20. The method of claim 17 wherein:
receiving identification of at least one participant computer includes receiving identification of at least one participant computer from a test conductor operating a test computer; and
receiving the test data includes automatically receiving the test data from test equipment operatively connected to the test computer.

21. The method of claim 20 wherein the test equipment is an x-ray test machine.

22. The method of claim 20 wherein the test equipment is an ultrasonic test machine.

23. The method of claim 20 wherein the test equipment is one of an eddy current test machine and an infrared thermal imaging test machine.

24. The method of claim 17 wherein the method further comprises:
in response to sending at least a portion of the received test data to each identified participant computer, receiving, from at least one participant computer, a comment related to the test data.

25. The method of claim 24 wherein receiving the comment includes receiving audio content.

26. The method of claim 24 wherein receiving the comment includes receiving textual content.

27. A method in a computer system for providing test data to distributed participants, the method comprising:
receiving, from a user, identification of at least one participant computer that will receive the test data;
sending the received identification to a server computer;
receiving, from test equipment, the test data; and
in response to receiving the test data, sending the test data to the server computer.

28. The method of claim 27 further comprising:
in response to sending the test data to the server computer, receiving, from the server computer, a display page containing at least a portion of the sent test data; and
displaying the received display page.

29. The method of claim 27 further comprising:
receiving, from the server computer, a comment related to the test data; and
presenting the received comment.

30. The method of claim 29 wherein the received comment contains audio content.

31. The method of claim 29 wherein the received comment contains textual content.

32. The method of claim 27 wherein the received test data includes operating parameters of the test equipment.

33. The method of claim 27 wherein the test equipment is an x-ray test machine and the test data includes x-ray images.

34. The method of claim 27 wherein the test equipment is ultrasonic test equipment and the test data includes ultrasonic images.

35. The method of claim 27 wherein the test equipment is an eddy current test machine and the test data includes numerical data.

36. The method of claim 27 wherein the test equipment is an infrared thermal imaging test machine and the test data includes thermal images.

37. The method of claim 27 further comprising:
receiving, from a user, a control input; and
sending the control input to the test equipment, wherein the test data is received from the test equipment in response to sending the control input to the test equipment.

38. The method of claim 27 wherein the received test data is first test data, and wherein the method further comprises:
after receiving the first test data, receiving, from a user, a control input;
sending the control input to the test equipment;
receiving, from the test equipment, second test data; and
in response to receiving the second test data, sending the second test data to the server computer.

39. A computer system for providing distributed participants with test data, the computer system comprising:
means for receiving identification of at least one participant computer that will receive the test data;
means for receiving the test data;
means for sending the received test data to an application program in response to receiving the test data; and
means for sending a display page generated by the application program to each identified participant computer, the display page containing at least a portion of the received test data.

40. The computer system of claim 39 wherein the test data is received and sent to the application program in real time.

41. The computer system of claim 39 wherein:
the means for receiving identification of at least one participant computer includes means for receiving identification of at least one participant computer from a test computer located in a first location; and
the means for sending a display page generated by the application program to each identified participant computer includes means for sending the display page to a first participant computer and a second participant computer, the first participant computer being located in a second location remote from the first location and the second participant computer being located in a third location remote from the first and second locations.

42. The computer system of claim 39 wherein:
the means for receiving identification of at least one participant computer includes means for receiving identification of at least one participant computer from a test computer; and
the means for receiving the test data includes means for automatically receiving the test data from the test computer, the test data being generated by test equipment operatively connected to the test computer.

43. The computer system of claim 42 wherein the test equipment is an x-ray test machine.

44. The computer system of claim 42 wherein the test equipment is an ultrasonic test machine.

45. The computer system of claim 42 wherein the test equipment is one of an eddy current test machine and an infrared thermal imaging test machine.

46. The computer system of claim 39 wherein the means for receiving identification of at least one participant computer includes means for receiving identification of at least one participant computer from a test computer, wherein the display page is a first display page, and wherein the computer system further comprises:
means for receiving, in response to sending the first display page generated by the application program to each identified participant computer, a comment related to the test data; and
means for sending at least a portion of the comment to the test computer.

47. The computer system of claim 46 wherein the means for receiving the comment includes means for receiving audio content, and wherein the means for sending at least a portion of the comment includes means for sending audio content.

48. The computer system of claim 46 wherein the means for receiving the comment includes means for receiving textual content, and wherein the means for sending at least a portion of the comment includes means for sending textual content.

49. The computer system of claim 39 wherein the means for receiving identification of at least one participant computer includes means for receiving identification of at least one participant computer from a test computer, wherein the display page is a first display page, and wherein the computer system further comprises:
means for receiving, in response to sending the first display page generated by the application program to each identified participant computer, a comment related to the test data;
means for sending, in response to receiving the comment, the received comment to the application program; and
means for sending a second display page generated by the application program to at least the test computer, the second display page containing at least a portion of the received comment.

50. The computer system of claim 39 further comprising:
means for receiving a part identifier, wherein the part identifier identifies the part associated with the test data;
means for retrieving, in response to receiving the part identifier, part data associated with the identified part from a database; and
means for sending the retrieved part data to the application program, wherein the display page generated by the application program includes at least a portion of the retrieved part data.

51. The computer system of claim 39 further comprising:
means for receiving a part identifier, wherein the part identifier identifies the part associated with the test data;
means for retrieving, in response to receiving the part identifier, part data associated with the identified part from a database; and
means for sending the retrieved part data to the application program, wherein the display page generated by the application program includes analytical results based at least in part on the received test data and the retrieved part data.

52. A computer-readable medium whose contents cause a computer system to provide distributed participants with test data, the test data being provided by a method comprising:
receiving identification of at least one participant computer that will receive the test data;
receiving the test data;
in response to receiving the test data, sending the received test data to an application program; and
sending a display page generated by the application program to each identified participant computer, the display page containing at least a portion of the received test data.

53. The computer-readable medium of claim 52 wherein:
receiving identification of at least one participant computer includes receiving identification of at least one participant computer from a test computer located in a first location; and
sending a display page generated by the application program to each identified participant computer includes sending the display page to a first participant computer and a second participant computer, the first participant computer being located in a second location remote from the first location and the second participant computer being located in a third location remote from the first and second locations.

54. The computer-readable medium of claim 52 wherein:
receiving identification of at least one participant computer includes receiving identification of at least one participant computer from a test computer; and
receiving the test data includes automatically receiving the test data from the test computer, the test data being generated by test equipment operatively connected to the test computer.

55. The computer-readable medium of claim 54 wherein the test equipment is an x-ray test machine.

56. The computer-readable medium of claim 52 wherein receiving identification of at least one participant computer includes receiving identification of at least one participant computer from a test computer, wherein the display page is a first display page, and wherein the method further comprises:
in response to sending the first display page generated by the application program to each identified participant computer, receiving, from at least one participant computer, a comment related to the test data; and
sending at least a portion of the comment to the test computer.

57. The computer-readable medium of claim 56 wherein receiving the comment includes receiving audio content, and wherein sending at least a portion of the comment includes sending audio content.

58. The computer-readable medium of claim 56 wherein receiving the comment includes receiving textual content, and wherein sending at least a portion of the comment includes sending textual content.

59. The computer-readable medium of claim 52 wherein receiving identification of at least one participant computer includes receiving identification of at least one participant computer from a test computer, wherein the display page is a first display page, and wherein the method further comprises:
in response to sending the first display page generated by the application program to each identified participant computer, receiving, from at least one participant computer, a comment related to the test data;
in response to receiving the comment, sending the received comment to the application program; and
sending a second display page generated by the application program to at least the test computer, the second display page containing at least a portion of the received comment.

60. The computer-readable medium of claim 52 further comprising:
receiving a part identifier, wherein the part identifier identifies the part associated with the test data;
in response to receiving the part identifier, retrieving part data associated with the identified part from a database; and
sending the retrieved part data to the application program, wherein the display page generated by the application program includes at least a portion of the retrieved part data.

61. The computer-readable medium of claim 52 further comprising:
receiving a part identifier, wherein the part identifier identifies the part associated with the test data;
in response to receiving the part identifier, retrieving part data associated with the identified part from a database; and
sending the retrieved part data to the application program, wherein the display page generated by the application program includes analytical results based at least in part on the received test data and the retrieved part data.

62. The computer-readable medium of claim 61 wherein the retrieved part data includes at least one of operating conditions and design details.

63. A computer-readable medium containing a display page configured to provide information related to a test being conducted by a test conductor in a first location to a distributed participant in a second location remote from the first location, the display page comprising:
a part information portion containing information about a part being tested by the test;
a test equipment information portion containing information about test equipment performing at least a portion of the test;
a test data portion containing test data resulting from the test; and
a text box, the text box configured to receive and display textual messages provided by at least one of the test conductor and the distributed participant.

64. The computer-readable medium of claim 63 wherein the part information portion includes a part number and a date, the part number identifying the part being tested and the date indicating when the part was first placed in service.

65. The computer-readable medium of claim 63 wherein the test equipment information portion includes an equipment number and a date, the equipment number identifying at least one piece of test equipment performing the test and the date indicating when the piece of equipment was last calibrated.

66. The computer-readable medium of claim 63 wherein the part information portion includes an identification of the manufacturer and a repair history of the part being tested, and wherein the test equipment information portion includes one or more control settings for at least one piece of test equipment performing the test.

67. The computer-readable medium of claim 63 wherein the test data portion includes graphical data and numerical data.

68. The computer-readable medium of claim 63 wherein the display page further comprises a voice button, wherein selection of the voice button by one of the test conductor or the distributed participant enables audio content to be sent by the one of the test conductor or the distributed participant to the other of the test conductor or the distributed participant.

69. A method in a computer system for allowing a distributed participant to participate remotely in a nondestructive evaluation (NDE) test of a part using NDE test equipment, the method comprising:
receiving NDE test conditions from the NDE test equipment;
sending the received NDE test conditions to the distributed participant;
receiving NDE test data from the NDE test equipment;
sending the received NDE test data to the distributed participant;
receiving an instruction from the distributed participant, the instruction being related to at least one of the NDE test conditions; and
in response to receiving the instruction, controlling the NDE test equipment to alter at least one of the NDE test conditions.

70. The method of claim 69 further comprising:
receiving an identification of the NDE test equipment; and
sending the received identification to the distributed participant.

71. The method of claim 69 further comprising;
receiving an identification of the part being tested; and
sending the received identification to the distributed participant.
